(19) United States
(12) Patent Application Publication
(10) Pub. No.: US 2011/0314061 A1
(43) Pub. Date: Dec. 22, 2011

(54) PREFERENCE SHARING METHOD

(76) Inventor: MARCOS LARA, NEW YORK, NY (US)

(21) Appl. No.: 12/964,470

(22) Filed: Dec. 9, 2010

Related U.S. Application Data
(60) Provisional application No. 61/285,146, filed on Dec. 9, 2009.
(60) Provisional application No. 61/321,443, filed on Apr. 6, 2010.
(60) Provisional application No. 61/323,540, filed on Apr. 13, 2010.
(60) Provisional application No. 61/323,456, filed on Apr. 13, 2010.

(51) Int. Cl. G06F 17/30

(52) U.S. Cl. 707/780; 707/E17.014

(57) ABSTRACT

A computer implemented method of sharing preferences of selections of digital material that may be related to an activity of mutual interest to two or more individuals. The method may first determine a user's preferred parameter space by combining a set of preferred ranges as they relate to each of a set of attributes by sampling selections made by the user when using a particular device. This may then be used to find in-range material among a second user's selections and metadata related to the material exchanged, including a location of a digital mechanical. The application module may also create subject vectors that are linear array of tags that are relevant to music, for each user. These subject vectors may be compared in order to create a combined user subject vector. This may be used to suggest further selections.

### CLAIM OF PRIORITY

This application claims priority to U.S. Provisional Patent No. 61/285,146 entitled “Sharing Metadata on Mobile Platforms” filed on Dec. 9, 2009, the contents of which are fully incorporated herein by reference. This application also claims priority to U.S. Provisional Patent No. 61/321,443 entitled “Metadata combination for serialized content delivery to “N” users” filed on Apr. 6, 2010, U.S. Provisional Patent No. 61/323,540 entitled “Authentication System for a Mobile-enabled data sharing application” filed on Apr. 13, 2010 and to U.S. Provisional Patent No. 61/323,456 entitled “Vertical Neutral “N” User Metadata Comparisons” filed on Apr. 13, 2010 the contents of all of which are fully incorporated herein by reference.

### FIELD OF THE INVENTION

The invention relates to a computer implemented method of sharing preferences of an activity, and more particularly to computer implemented methods of sharing preferences by examination and comparison of meta data regarding user selections of digital material related to the activity.

### BACKGROUND OF THE INVENTION

Sharing information about topics of mutual interest appears to be a deeply ingrained human activity. As digital content for most media becomes available in file sizes that are easily contained in mobile electronic devices, and easily and quickly transferred across available digital communications bandwidths, this human inclination to share information raises a number of problems including the shear volume of information available to share and the difficulty of content creators to receive adequate compensation for their creativity.

The present invention addresses these issues by helping automate the process of discovering and sharing digital content related to a particular activity by examining and exchanging meta data regarding digital content that may be on a user's mobile digital device, including addresses of sites the content may be streamed from. By relying on meta data, the information exchange may occur rapidly, even when each user has a large repertoire of interest, and the digital content remains “locked and licensed” but readily available over a streaming connection that may monitor and account for actual use of the digital content.

### DESCRIPTION OF THE RELATED ART

The relevant prior art involving exchanging preferences using metadata includes:

US Patent Application no. 20070288470 by Kauniskangas et al. published on Dec. 13, 2007 entitled “Selection of media for public rendering via user devices” that describes selecting media for public rendering via user devices involves coupling one or more proximately co-located mobile devices to a network. Metadata of the mobile devices is discovered via the network. The metadata is indicative of media preferences of users associated with the mobile devices. The metadata is correlated to determine media selections in accordance with the media preferences of the users, and the media selections are publicly rendered for the users.

U.S. Pat. No. 6,928,433 issued to Goodman, et al. on Aug. 9, 2005 entitled “Automatic hierarchical categorization of music by metadata” that describes a method, performed by software executing on the processor of a portable music playback device, that automatically files tracks according to hierarchical structure of categories to organize tracks in a logical order. A user interface is utilized to change the hierarchy, view track names, and select tracks for playback or other operations.

U.S. Pat. No. 7,672,962 issued to Arrouye, et al. on Mar. 2, 2010 entitled “Methods and systems for managing data” that describes systems and methods for managing data, such as metadata or indexes of content of files. In one exemplary method, notifications to update a metadata database or an index database are combined into a combined notification. According to other aspects, an order among logical locations on a storage device is determined in order to specify a sequence for scanning for files to be indexed. According to another aspect, a method includes determining whether to index a file based on a path name of the file relative to a plurality of predetermined path names.

U.S. Pat. No. 7,818,350 issued to New, et al. on Oct. 19, 2010 entitled “System and method for creating a collaborative playlist” that describes a method, server, and user interface associated with creating a collaborative playlist between one or more users based on user interaction with a media program. In one embodiment, the media program is an instant messaging application.

Various implements are known in the art, but fail to address all of the problems solved by the invention described herein. One embodiment of this invention is illustrated in the accompanying drawings and will be described in more detail herein below.

### SUMMARY OF THE INVENTION

The present invention relates to computer implemented methods of sharing preferences of selections of digital material that may be related to an activity of mutual interest to two or more individuals.

In a preferred embodiment, a user's preferred parameter space may be determined. For instance if the activity involves listening to music, the attributes may be measurable items such as, but not limited to, the beats per minute, timbre or cadence of the music, or some combination thereof. Or the attributes may be of a more subjective nature such as, but not limited to danceability, energy, hottness, obscurity or some combination thereof.

A computer, or an application module running on one, may first obtain a user's preferred range as it relates to each of a particular set of attributes. This may, for instance, be done by sampling the selections of digital material made by the user when using a digital electronic performance device, such as, but not limited to, a cell phone or a mobile tablet.

The computer, or application module, may then combine the preferred ranges of two or more attributes to form a preferred parameter space for the user, and that parameter space may be used to find one or more items of in-range digital material among a second user's selections of digital material made while using their digital electronic performance device.

The user's devices may then exchange metadata related to the in-range digital material, including informing first user of a location of a digital mechanical of the in-range selection.

In a further, preferred embodiment, an application module running on the digital electronic performance device may sample the first user's selections to create a first user subject vector. The subject vector may, for instance, be a linear array of tags and weighting factors associated with the tags. For instance if the subject is music, the tags may, for instance, be items such as, but not limited to, a method of production, a performer of a selection, a style of performance of a selection, a producer of a selection, a style of production of a selection, an ethnicity associated with a performer, a producer or a style of production, a region or location associated with a performer, a producer or a style of production, or some combination thereof.

The second user may use a similar process to create their subject vector. A computer may then compare the subject vectors and create a combined user subject vector. This combined user subject vector may then be used to provide one or more suggested selections. Metadata associated with those suggested selections may then be exchanged. The metadata may include one or more URLs of currently known, locations of a mechanical for the selection that may be accessed by the digital electronic performance device in a streaming mode.

Therefore, the present invention succeeds in conferring the following, and others not mentioned, desirable and useful benefits and objectives.

It is an object of the present invention to provide a method of exchanging preferences that is both easy and safe.

It is another object of the present invention to provide selections that are new to both parties and fit their preferences.

Yet another object of the present invention is to provide a way for users to jointly explore new experiences.

### BRIEF DESCRIPTION OF THE DRAWINGS

FIG. 1 shows a schematic overview of a content distribution and monitoring system in accordance with a preferred embodiment of the present invention.

FIG. 2 shows a flow diagram of steps that may be taken to share preferences in a preferred embodiment of the present invention.

FIG. 3 shows a more detailed flow diagram of steps that may be taken to share preferences in a preferred embodiment of the present invention.

FIG. 4 shows a schematic interaction diagram showing interactions that may occur in sharing preferences in a preferred embodiment of the invention.

FIG. 5 shows a schematic interaction diagram showing interactions that may occur in implementing a preferred embodiment of the invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto. In particular, the following description of the present invention is presented as pertaining to the distribution, consumption and accounting for digital music. One of ordinary skill in the art will readily appreciate that the inventive concepts discussed below may readily be adapted for use in other digital media such as, but not limited to, text, images and video, or some combination thereof.

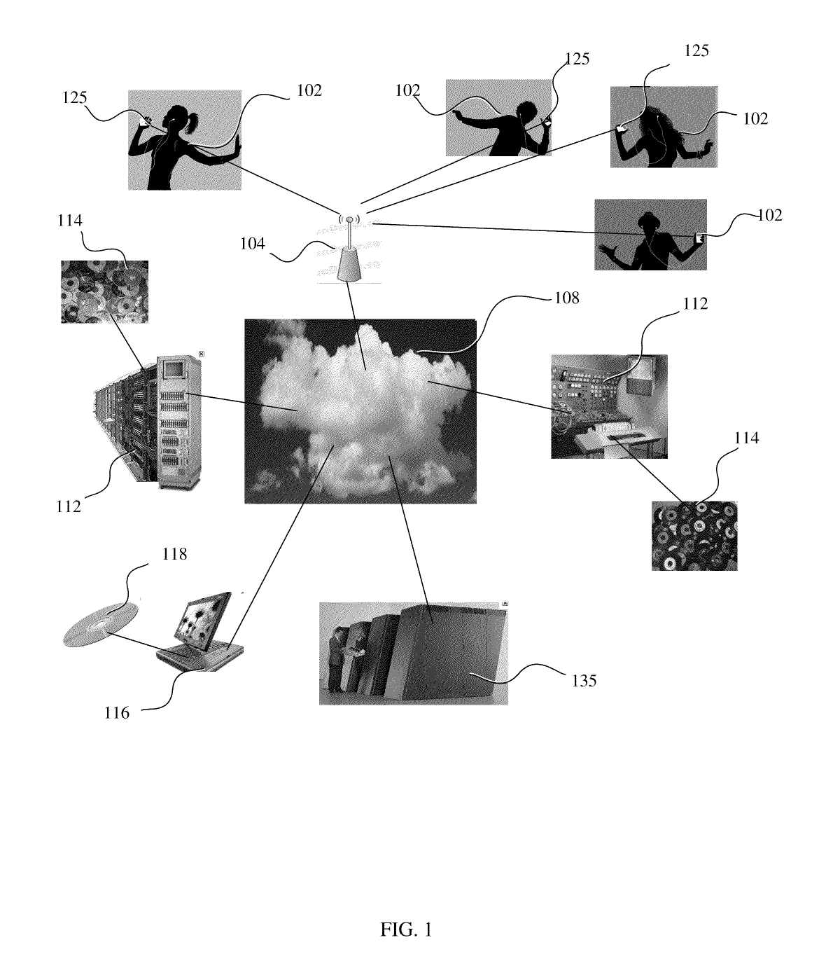

FIG. 1 shows a schematic overview of a content distribution and monitoring system in accordance with a preferred embodiment of the present invention.

The users 102 may be using their digital electronic performance devices 125 to access third party music archives 114 via one or more third party servers 112 via the Internet 108 and suitable wireless transmission hardware 104.

The users 102 may also be communicating with each other using their digital electronic performance device 125. That communication may, for instance, be in a form such as, but not limited to, texting, instant messaging, emailing, voice over internet protocol (VoIP), or some combination thereof.

The user 102 and their digital electronic performance devices 125 may, for instance, be coordinated via a network computer 135 that may facilitate the user interaction and access to the third party music archives 114.

In order to do this, the network computer 135 may operate in concert with the user's 102 digital electronic performance devices 125 and software application modules running on them, to enable users to share music preferences with each other. In order to avoid unlawful exchange of music performance files, or mechanicals, the exchange of preference may, for instance, be done using metadata related to a user's 102 history of selecting songs to listen to. The metadata exchanged may also include locations such as, but not limited to, universal resource locators, that may enable the users to obtain streaming performances from mechanicals stored on third party music archives. In a preferred embodiment, the application module 180 on the digital electronic performance device 125 may ensure that the delivered music is not able to be copied and that the performance of the music is accounted for and the rights holders informed of the performance.

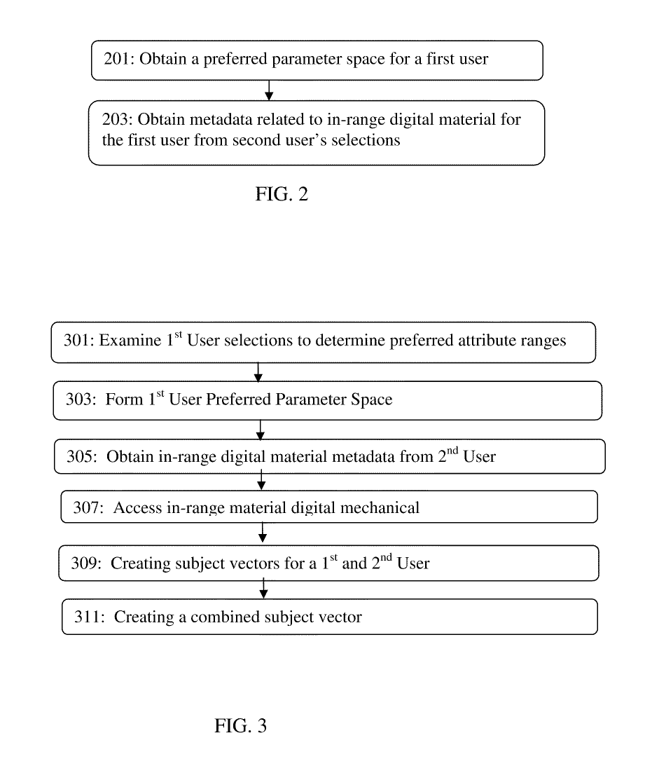

FIG. 2 shows a flow diagram of steps that may be taken to share preferences in a preferred embodiment of the present invention.

In Step 201: Obtain a preferred parameter space for a first user. This may be a first step in sharing preference and may be done by first obtaining a first user's preferred range of two or more attributes.

In a music context, the attributes may be substantially objective measures such as, but not limited to, beats per minute, timbre and cadence, or some combination thereof. Or the attributes may be more subjective characterizations of music such as, but not limited to, danceability, energy, hottness and obscurity.

The first user's preferred range of an attributes may, for instance, be obtained by examining a usage history of their digital electronic performance device 125 in order to find statistically significant occurrences of selections of digital material. This may be examined, or compared to selection databases that may have been compiled with input from musicians or other expert judges of musicality, and a preferred range of a particular attribute arrived at.

This process may be repeated for a number of attributes, and then they may be combined to define a preferred parameter space for the first user.

Having obtained the preferred parameter space for a first user, the next step of the method may then be Step 203: Obtain metadata related to in-range digital material for the first user from second user's selections.

This may, for instance, be accomplished by the first user sending the second user a copy of their preferred parameter space. The second user's digital electronic performance device 125 or an application module 180 running on it, may then examine a history of the second user's selections 212 of digital material looking for material that has attribute ranges that fall within the first user’ preferred parameter space. When such in-range digital material 210 is located, metadata relating to the in-range digital material 210 may be sent to the first user. The metadata may include a URL of one or more known locations of a digital content file, sometimes called the mechanical digital content file, sometimes called the mechanical, so that the first user may listen to the song in a manner that is legal and compensates the rights holder of the material.

FIG. 3 shows a more detailed flow diagram of steps that may be taken to share preferences in a preferred embodiment of the present invention.

In Step 301: Examine 1st User selections to determine preferred attribute ranges, the user's selection history may be examined, as explained in detail above.

In Step 303: Form 1st User Preferred Parameter Space, the attribute ranges obtained in Step 301 may be combined, as explained in detail above.

In Step 305: Obtain in-range digital material metadata from a 2nd user, a second user's selection history may be examined for selections that fall within the first user's preferred parameter space. Metadata, that may include URLs for digital content file, sometimes called the mechanicals digital content file, sometimes called the mechanical, may then be transmitted to the first user as explained in detail above.

In Step 307: Access in-range material digital mechanical, the first user may use the URLs obtained in Step 305 and access a streaming performance of a selection. The digital content file, sometimes called the mechanical digital content file, sometimes called the mechanical may, for instance, be located on a third party music archive 114 and may be accessed via a third party server 112 and the Internet 108. In a preferred embodiment, the application module 180 and a network computer 135 may mediate the streaming performance and ensure that the digital content file, sometimes called the mechanical digital content file, sometimes called the mechanical may not be copied and that the performance may be properly accounted for.

In Step 309: Creating subject vectors for a 1st and 2nd User, the application module 180 running on the user's digital electronic performance device 125 or the network computer 135, or some combination thereof, may sample each of the user's selections to create user subject vector for each of them. The subject vectors may, for instance, be limited to selections that are in-range selections for both users. The subject vectors may, for instance, be a linear array of tags and weighting factors associated with the tags. If the subject is, for instance, music, the tags may, for instance, be items such as, but not limited to, a method of production, a performer of a selection, a style of performance of a selection, a producer of a selection, a style of production of a selection, an ethnicity associated with a performer, a producer or a style of production, a region or location associated with a performer, a producer or a style of production, or some combination thereof.

The weighting factors may, for instance, be related to the relative frequency of a particular tag found in a users selection history. The weighting factor may also be weighting by time of the selection.

Although the discussion above relates to music, one of ordinary skill in the art will readily appreciate that a similar method may be used for other subjects such as, but not limited to, food, beverages, films, literature, magazines, poetry, dance, people, venues or some combination thereof.

In Step 311: Creating a combined subject vector, the two subject vectors created in Step 309 may be combined to form a common subject vector.

This subject vector may, for instance, be used by the network computer 135 to obtain one or more selections that may be novel to both users, but fall within their combined preferred parameter space. In this way, the users may, for instance, be facilitated to share new experiences together.

The network computer 135 may monitor a number of user 102 digital electronic performance devices 125 and gather data to provide a heat map graphic displaying a location of an occurrence of a selection.

By further monitoring of other data on the digital electronic performance device 125, such as, but not limited to, users exchanging text messages, the network computer 135 may locate occurrences of a selection that are a live performance of the selection, a public rendition of the selection, a private rendition of the selection, or some combination thereof.

The heat map graphic generated by the network computer 135 may also include a time-to-live (TTL) for some or all of the selections. The time-to-live may be indicative of a period of time during which the occurrence of the selection is, will or has happened, and may, for instance, be conveyed by a graphic element such as, but not limited to, a color, a digit, a size of an object, a position of one object relative to another, or some combination thereof.

The comparison of subject vectors may, for instance, be done using a well known method such as, but not limited to, an edit distance comparison.

The user preferred parameter spaces and subject vectors may, for instance, be calculated using one or more events as start points. For instance, the start point may be the date of an event such as, but not limited to, a date of a performance by a particular artist or group at a particular venue, a date of a release of a particular song, of a movie, of a death, or some combination thereof.

The network computer 135 may also monitoring user satisfaction and may adjust or abandon current vector dependant on the results of the monitoring.

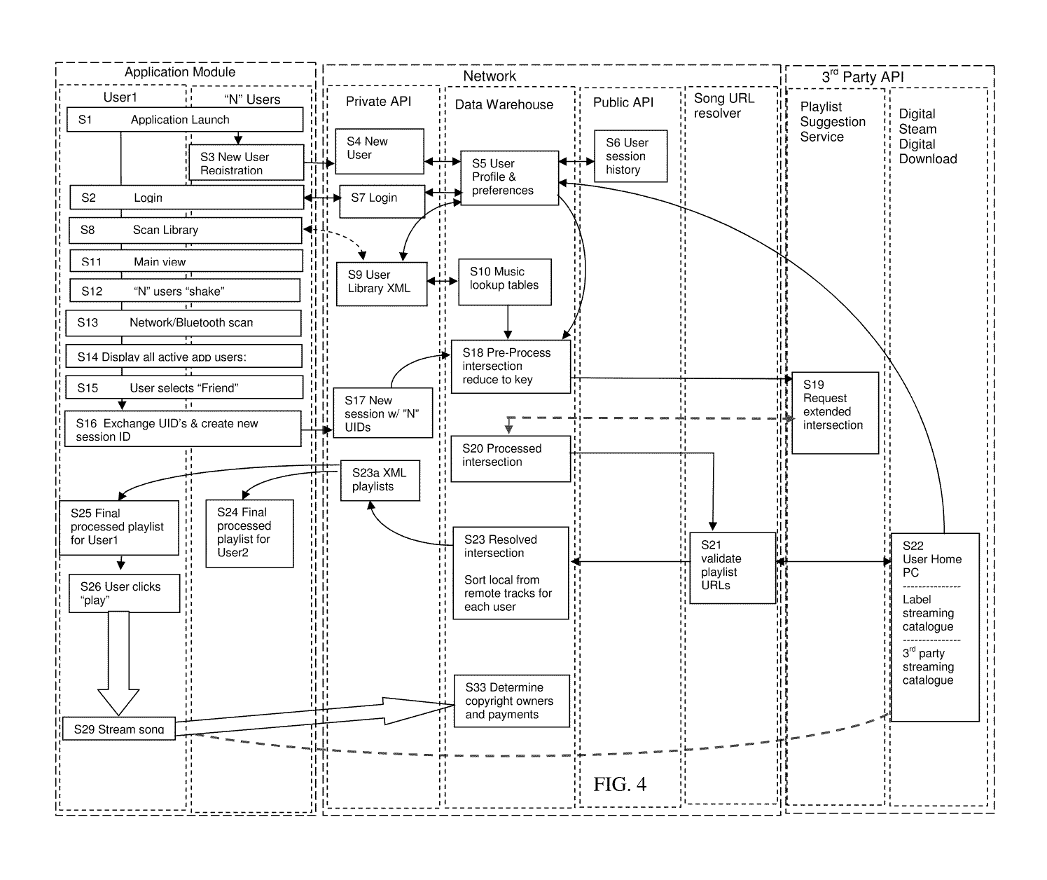

FIG. 4 shows a schematic interaction diagram showing interactions that may occur in sharing preferences in a preferred embodiment of the invention.

In step S1 “Application Launch”, an application module 180 may be initiated on a digital electronic performance device 125.

In step S2, “Login”, the application module 180 may require a username and password and may then provide access to a network computer 135 via the Internet 108.

If the user is new to the system, the application module 180 may proceed instead to “New User Registration” and obtain relevant user information such as, but not limited to, email address, username, selection of password, telephone number, physical address or some combination thereof.

Having obtained the relevant information, the application module 180 may then provide the digital electronic performance device 125 access to the network computer 135 that may, for instance, be via the Internet 108. In step S4, “New User”, the network computer 135 may request further information such as, but not limited to, a credit card number, a bank account number or some combination thereof.

The network computer 135 may then, in step S5 “User Profile & preferences” provide access to a data warehouse having the users profile and preferences. The network computer 135 may also provide access to step S6 “User session history”.

In step S8 “Scan Library”, the application module 180 may scan the users store of music and music preferences that may include using a private API in step S9 “User Library” to access the information.

In step S10 “Music lookup tables” S10 the network computer may access the API of S(and pass appropriate details on to step S18.

In step S11 “Main view” an overview of the library contents may be displayed.

In step S12 “N” users “shake”, two or more users may establish communication with each other by each shaking their digital electronic performance devices 125 at substantially the same time.

In step S13 “Network/Bluetooth scan” the application module 180 may perform a scan that may locate other users running the same or similar application that may be in substantially the same location. The scan may, for instance, be performed using a wireless communication protocol such as, but not limited to, Bluetooth. Or the scan may be performed by the network computer 135 using a locator such as, but not limited to, a GPS locator transmitted by the digital electronic performance devices.

In step S14, “Display all active app users”, a.k.a. “shakers” the application module 180 may display all the users having devices on which the application module 180, or a compatible module, may be current active or running and which may be in substantially the same geographic location.

In step S15, User selects “Friend”, a user may initiate contact with one or more of the active users.

In step S16, “Exchange UID's & create new session ID”, the first user and the friend selected in step S15 may exchange their user identifications and may create a new interaction session having a new session identifier.

In step S17, “New session w/“N” UIDs” the information may be passed via a private API so that the new session may be activated on the network computer 135.

In step S18, “Pre-Process intersection reduce to key pivot songs” the network computer 135 may perform a preliminary examination of the user's selection histories and, based on particular songs that may be known to have strong correlations with certain musical attributes, may produce a preliminary intersection of the user's selections.

In step S19 “Request extended intersection” the network computer 135 may access a 3^{rd} party playlist suggestion service. Such a service usually provides an individual suggesting for new material based on their individual selection history. In a preferred embodiment of the present invention the new material is provided based on hypothetical person having a hypothetical selection history that is representative of a combination of the two users. This combination may, for instance, be a junction such as, but not limited to, an intersection, a union, a distance in edit space or some combination thereof.

In step S20 “Processed intersection” the network computer 135 retrieves the processed intersection that may, for instance, be a selection of material that is new to the hypothetical combined user.

In step S21 “validate playlist URLs” the network computer 135 may ensure that the URLs supplied by the playlist suggestion service are still valid by, for instance, “pinging” or otherwise interaction with the label or 3^{rd} party streaming catalogues that may be located on the digital stream download servers.

In step S23, “Resolved intersection Step” S23: Sort local from remote tracks for each user, the network computer 135 may sort the suggested playlist for each of the users, distinguishing between which digital content file, sometimes called the mechanicals digital content file, sometimes called the mechanical they already have direct access to and which they may have to use a URL to locate.

In step S23a the “XML playlists”, the new playlists that the network computer 135 may have formatted using a format such as, but not limited to, the extensible markup language (XML) or some suitable formatting language, may be made available for the application module.

In step S24 “Final processed playlist for User2” a version of the new playlist may be delivered to the application module 180 running on the second user's digital electronic performance device 125. Similarly in step S25 “Final processed playlist for User1” a version of the new playlist.

In step S26, User clicks “play” the user may initiate playing of a selection from the playlist.

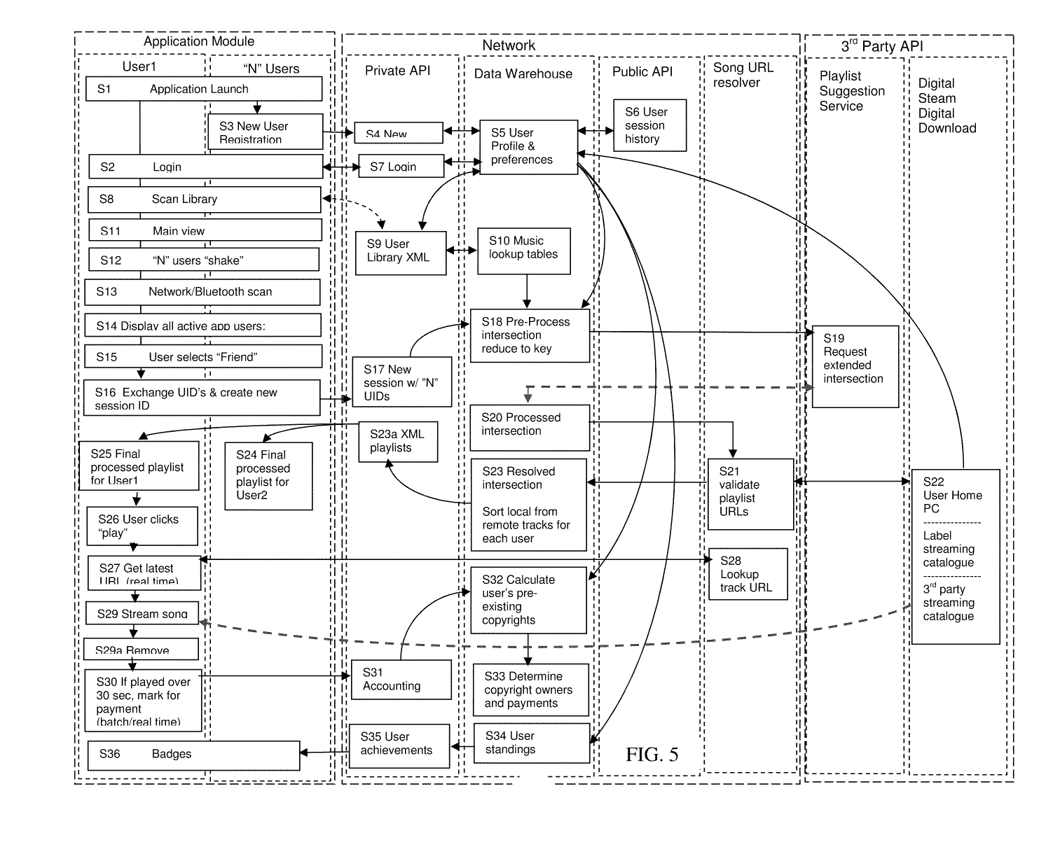

The application module 180 then proceed via steps shown in detail in FIG. 5, to step S29 “Stream song” in which the song may be streamed to the user.

In a preferred embodiment, the application module 180 may then proceed via steps shown in detail in FIG. 5 to step S33 “Determine copyright owners and payments” in which appropriate payments due may be calculated and may be communicated to the appropriate rights holding parties.

FIG. 5 shows a schematic interaction diagram showing interactions that may occur in implementing a preferred embodiment of the invention. The relevant steps are described in detail above.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. A method of sharing preferences of selections related to an activity, said method comprising the steps of:
obtaining a preferred range of two or more attributes for a first user by using a computer, to sample said first user's selections of digital material related to said activity;
forming, using said computer, a first user preferred parameter space by combining said two or more preferred ranges of said two or more attributes; and
obtaining, if possible, meta-data related to one or more items of in-range digital material related to said activity from a second user's selections of digital material related to said activity, said in-range digital material having attributes within said preferred parameter space.

2. The method of claim 1 further comprising informing said first user of a location of a digital mechanical of said in-range selection.

3. The method of claim 1 wherein said activity comprises listening to music and wherein said attribute is selected from the group comprising beats per minute, timbre and cadence.

4. The method of claim 1 wherein said activity comprises listening to music and wherein said attribute is selected from the group comprising danceability, energy, hottness and obscurity.

5. The method of claim 1 further comprising using a sample of said first user's selections to create, using a computer, a first user subject vector having at least one in-range selection;
using a sample of a second user's selections to create, using said computer, a second user subject vector having, if possible, at least one in-range selection;
comparing said selection vectors, using said computer, to create a combined user subject vector; and
using said combined user subject vector to provide, using said computer, one or more suggested selections related to said subject.

6. The method of claim 5 wherein said subject is one of music, food, beverages, films, literature, magazines, poetry, dance, people, venues or some combination thereof.

7. The method of claim 5 wherein said subject vectors comprise a linear array of tags and weighting factors associated with said tags.

8. The method of claim 7 wherein said tags include one of a method of production, a performer of a selection, a style of performance of a selection, a producer of a selection, a style of production of a selection, an ethnicity associated with a performer, a producer or a style of production, a region or location associated with a performer, a producer or a style of production, or some combination thereof.

9. The method of claim 5 further comprising delivering a mechanical of one or more of said suggested selections.

10. The method of claim 9 wherein delivering further comprises providing a central repository containing mechanicals of one or more selections.

11. The method of claim 9 wherein delivering further comprises providing a URL of current location of a mechanical.

12. The method of claim 5 further comprising providing a heat map graphic displaying a location of an occurrence of a selection.

13. The method of claim 12 wherein said occurrence of a selection further comprises one of a live performance of said selection, a public rendition of said selection, a private rendition of said selection, or some combination thereof.

15. The method of claim 12 wherein said heat map graphic further comprise a time-to-live (TTL), said time-to-live being indicative of a period of time during which said occurrence is, will or has happened.
